(19) United States
(12) Patent Application Publication
(10) Pub. No.: US 2026/0021653 A1
(43) Pub. Date: Jan. 22, 2026

(54) LAMINATION-FORMING SYSTEM AND METHOD OF MANUFACTURING LAMINATION-FORMED PRODUCT

(71) Applicant: THE JAPAN STEEL WORKS, LTD., Tokyo (JP)

(72) Inventors: Takayuki YAMAMOTO, Tokyo (JP); Takashi Nagai, Tokyo (JP); Keiichirou Sugisaki, Tokyo (JP); Naoki Ueda, Tokyo (JP)

(21) Appl. No.: 19/264,622

(22) Filed: Jul. 9, 2025

(30) Foreign Application Priority Data
Jul. 19, 2024 (JP) 2024-116032

(51) Int. Cl. B32B 37/08; B32B 37/10; B32B 41/00

(52) U.S. Cl. CPC B32B 37/08; B32B 41/00; B32B 37/1018; B32B 2309/02; B32B 2309/06; B32B 2309/14

(57) ABSTRACT

A lamination-forming system according to the present disclosure includes: a pair of carrier films for sandwiching an object to be laminated between the pair of carrier films from above and below and conveying the object to be laminated along a conveyance direction; a film unwinder for unwinding the carrier film; a laminator for pressing the object to be laminated to form a lamination-formed product, the laminator being disposed on a downstream side with respect to the film unwinder; and a cooling unit configured to cool the lamination-formed product, the cooling unit being disposed on a downstream side with respect to the laminator. The cooling unit includes an airflow generation unit configured to cause a cooling air to flow in a direction inclined at a predetermined angle with respect to a direction substantially perpendicular to the conveyance direction, toward a downstream side in the conveyance direction.

### INCORPORATION BY REFERENCE

This application is based upon and claims the benefit of priority from Japanese patent application No. 2024-116032, filed on Jul. 19, 2024, the disclosure of which is incorporated herein in its entirety by reference.

### BACKGROUND

The present disclosure relates to a lamination-forming system and a method of manufacturing a lamination-formed product.

Japanese Patent No. 3821706 discloses a laminator in which continuous laminate films are superposed on both surfaces of a conveyed object to be laminated, and are pressed and laminated while being heated by a laminate roller. A cooling fan is provided on the downstream side with respect to the laminate roller. The cooling fan and the laminate roller are kept apart from each other so as to avoid the laminate roller from being cooled, and the cooling fan is inclined to the opposite side of the laminate roller.

### SUMMARY

There are laminating apparatuses provided with a plurality of cooling fans for uniformly cooling an object. When cooling air is caused to flow from a plurality of cooling fans in a direction perpendicularly to an object, the air flows toward a stage on the upstream side for performing lamination processing, which may cause contamination of the stage for performing lamination processing.

The present disclosure has been made in order to solve such a problem, and an object of the present disclosure is to provide a method of manufacturing a lamination-forming system and a lamination-formed product adapted to suppress contamination of a stage for performing lamination processing. Other problems and noble features will become apparent from the description of the present specification and the accompanying drawings.

According to the present disclosure, a lamination-forming system, includes:
a pair of carrier films for sandwiching an object to be laminated, formed by laminating a laminate material on a lamination-target body, between the pair of carrier films from above and below and conveying the object to be laminated along a conveyance direction;
a film unwinder for unwinding the carrier film;
a laminator for pressing the object to be laminated to form a lamination-formed product, the laminator being disposed on a downstream side with respect to the film unwinder;
a cooling unit configured to cool the lamination-formed product, the cooling unit being disposed on a downstream side with respect to the laminator; and
a film winder for unloading the lamination-formed product mounted on the carrier film, the film winder being disposed on the downstream side with respect to the laminator.

The cooling unit includes an air flow generation means for causing a cooling air to flow in a direction inclined at a predetermined angle with respect to a direction substantially perpendicular to the conveyance direction, toward a downstream side in the conveyance direction.

According to the present disclosure, a method of manufacturing a lamination-formed product, includes:
sandwiching an object to be laminated, formed by laminating a laminate material on a lamination-target body, between a pair of carrier films from above and below and conveying the object to be laminated along a conveyance direction;
pressing the conveyed object to be laminated to form a lamination-formed product;
performing cooling by an air flow generation means for causing a cooling air to flow in a direction inclined at a predetermined angle with respect to a direction substantially perpendicular to the conveyance direction, toward a downstream side in the conveyance direction; and
unloading the lamination-formed product mounted on the carrier film.

According to the present disclosure, it is possible to suppress contamination of a stage for performing lamination processing.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing a schematic configuration of a laminator according to a first embodiment;

FIG. 2 is a side view of a cooling apparatus shown in FIG. 1;

FIG. 3 is a top view of the cooling apparatus shown in FIG. 1;

FIG. 4 is a diagram showing a state in which an upper-side cooling fan is retracted from the cooling stage;

FIG. 5 is a diagram for explaining a mounting angle of the upper-side cooling fan;

FIG. 6 is a top view of a cooling apparatus according to a second embodiment; and

FIG. 7 is a side view of the cooling apparatus shown in FIG. 6.

### DESCRIPTION OF EMBODIMENTS

Hereinafter, the present disclosure will be described through the embodiments of the disclosure, but the claimed disclosure is not limited to the following embodiments. In addition, not all of the structures described in the embodiments are necessarily essential as a means for solving the problem. For the sake of clarification of the explanation, the following descriptions and drawings are omitted and simplified as appropriate. In each of the drawings, the same reference numerals are assigned to the same elements, and duplicate explanations are omitted as necessary. In the following description, the positional relationships indicated by terms such as “left”, “right”, “inside”, “outside”, “axis”, “center”, “horizontal”, and “orthogonal” are based on the positional relationships shown in the drawings, and are intended to facilitate the description of the embodiments of the present disclosure, and are not to be understood as limiting the embodiments of the present disclosure.

An embodiment of the present disclosure relates to a lamination-forming system including: loading, from one side, an object to be laminated obtained by laminating a laminate material on the lamination-target body; performing a lamination processing of pressing the object to be laminated under reduced pressure; and unloading the object to be laminated from the other side. Here, as an example of the object to be laminated, a substrate W to which at least a part of a laminate film is temporarily bonded will be described.

### First Embodiment

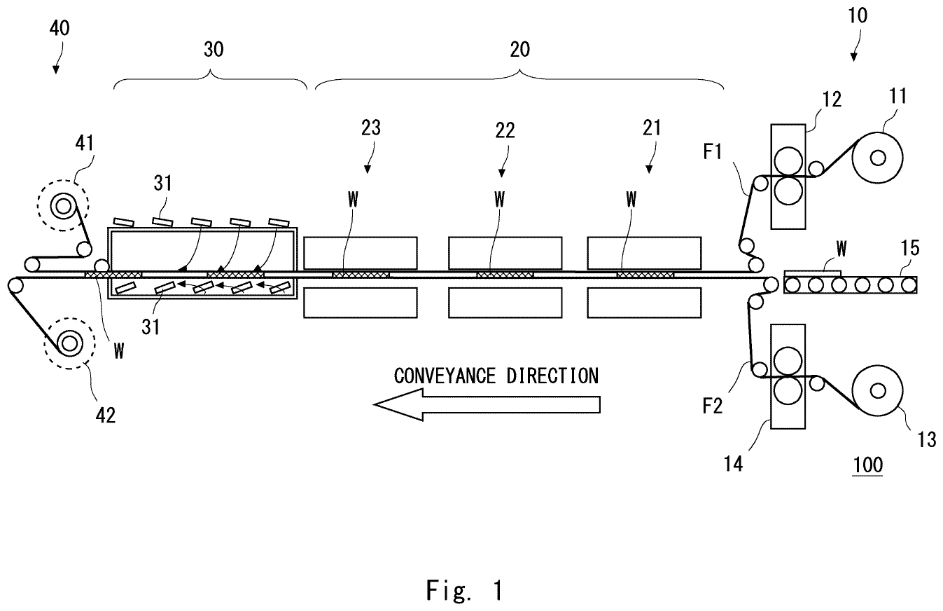

FIG. 1 is a diagram showing a schematic configuration of a laminator according to a first embodiment. As shown in FIG. 1, a lamination-forming system 100 includes a feeding apparatus 10, a forming apparatus 20, a cooling apparatus 30, and a collection apparatus 40.

The feeding apparatus 10 is provided in the system at a part preceding the forming apparatus 20 (i.e., on the upstream side with respect to the forming apparatus 20). The cooling apparatus 30 is provided in the system at a part following the forming apparatus 20 (i.e., on the downstream side with respect to the forming apparatus 20). The collection apparatus 40 is provided in the system at a part following the cooling apparatus 30 (i.e., on the downstream side with respect to the cooling apparatus 30). The forming apparatus 20 includes a first stage 21, a second stage 22, and a third stage 23. The second stage 22 and the third stage 23 are installed consecutively in the system at a part following the first stage 21 (i.e., on the downstream side with respect to the first stage 21). Hereinafter, an example in which a lamination processing is performed by a vacuum laminating apparatus on the first stage 21, planarization processing is performed by a first press apparatus on the second stage 22, and planarization processing is performed by a second press apparatus on the third stage 23 will be described. That is, in the example shown in FIG. 1, there are one “laminator” and two “planarization press apparatuses”.

The configuration of the forming apparatus 20 is merely an example and is not limited thereto. The forming apparatus 20 may be configured such that the substrate W is conveyed in progressive feed using a film, and may include at least the first stage 21. One or both of the second stage 22 and the third stage 23 may not be provided.

The feeding apparatus 10 includes an upper-film unwinding apparatus 11, an upper-film cleaning apparatus 12, a lower-film unwinding apparatus 13, a lower-film cleaning apparatus 14, and a substrate reception unit 15. The feeding apparatus 10 corresponds to a “film unwinder”. The upper-film unwinding apparatus 11 and the lower-film unwinding apparatus 13 are provided with film rolls in which band-shaped films are wound up. The upper-film unwinding apparatus 11 and the lower-film unwinding apparatus 13 feed a pair of carrier films for sandwiching the object to be laminated, which is a lamination-target body formed by laminating a laminate film as a laminate material on the substrate W, from above and below and conveying the object to be laminated along a conveyance direction.

The pair of carrier films are inserted into the lamination-forming system 100 and the substrate W, which is an object to be laminated, is conveyed from one end side of the lamination-forming system 100 toward the other end side along a conveyance face parallel to the hot plate of the lamination-forming system 100. Hereinafter, the carrier film unwound from the upper-film unwinding apparatus 11 is referred to as the upper film F1, and the carrier film unwound from the lower-film unwinding apparatus 13 is referred to as the lower film F2.

A laminate film (not shown) is disposed on the substrate W. The laminate film is a single sheet, and is set on the lower film F2 to be layered on the substrate W. The laminate film is coated with a heat-sensitive adhesive, for example, and can be adhered when heated. In setting the laminate of the laminate film and the substrate W on the lower film F2, at least a part of the laminate film may be temporarily bonded.

The upper-film cleaning apparatus 12 and the lower-film cleaning apparatus 14 include, for example, adhesive rollers. The upper-film cleaning apparatus 12 and the lower-film cleaning apparatus 14 catch and remove dust adhering to the upper-film F1 and the lower-film F2 by the adhesive rollers, respectively. The upper-film cleaning apparatus 12 and the lower-film cleaning apparatus 14 may have a function of collecting particles (dust foreign matters) generated in the lamination-forming system 100 and preventing the laminate film from being contaminated.

The substrate reception unit 15 feeds the substrate W between the upper-film F1 and the lower-film F2 at a predetermined timing so that the pitch between a substrate W and the subsequent substrate W is constant. The pitch between substrates W is equal to, for example, the spacing between the first stage 21, the second stage 22, and the third stage 23. Therefore, after processing is performed simultaneously for different substrates W on the respective stages of the first stage 21, the second stage 22, and the third stage 23, the substrate W on the first stage 21 is conveyed to the second stage 22, which is on the downstream side with respect to the first stage 21, and the substrate W on the second stage 22 is conveyed to the third stage 23. The substrate W on the third stage 23 is conveyed to the cooling apparatus 30, which is on the downstream side with respect to the third stage 23.

The feeding apparatus 10 may include at least one driven roller. The driven rollers change the orientations of the upper film and the lower film to be horizontal, respectively. The substrate W is fed to a part where the upper film and the lower film are horizontally oriented. The substrate W is transferred in a state of being sandwiched between the upper film F1 and the lower film F2. The substrate W sandwiched between the upper film F1 and the lower film F2 is processed on the first stage 21, the second stage 22, and the third stage 23, respectively.

In the embodiment, the forming apparatus 20 includes a laminator for performing a lamination processing of laminating an object to be laminated (the substrate W on which laminate films are layered) under reduced pressure. The substrate W is conveyed in a predetermined conveyance direction (in the direction of the white arrow in FIG. 1) along the conveyance face (the placement face of the substrate W on which the lower film F2 is placed in a horizontal state).

On the first stage 21, a lamination processing is performed by a vacuum laminator. In the vacuum laminator, a laminate consisting of the substrate W, an upper film F1, and a lower film F2 is heated and pressurized by a pressurizing body in a vacuum chamber (not shown). The form of the pressurizing body is not particularly limited, but it may be, for example, a material for expanding an elastic film such as a diaphragm, or a plate-like body having a pressurizing face made of resin such as elastomer or metal.

For example, in the vacuum laminator, a lower board is provided so as to be movable up and down with respect to a fixed upper board. A chamber is formed when the lower board rises and abuts against the upper board. A hot plate heated by a heater (not shown) is attached to the central lower face of the upper board, and a heat-resistant elastic sheet is attached to the surface of the hot plate.

On the other hand, a hot plate heated by a heater (not shown) is attached to the central upper face of the lower board. A diaphragm, which is a pressurized body, is attached to the surface of the hot plate of the lower board. When pressurized air is sent to the rear side of the diaphragm by a compressor (not shown), the diaphragm bulges in the chamber, and the laminate is pressurized between the hot plates. Thus, the substrate W is subjected to a lamination processing by the upper film F1 and the lower film F2, and the primary formed product is obtained. The configuration of the vacuum laminating apparatus described above is an example. For example, the diaphragm may be attached to the upper plate, and the substrate W may be pressed from the upper plate side. In the case where the lamination-forming system 100 includes only a laminator, the primary formed product is a lamination-formed product obtained by pressurizing the object to be laminated.

On the second stage 22, planarization processing can be performed by the first press apparatus. The first press apparatus further pressurizes the primary formed product subjected to a lamination processing by the vacuum laminator to increase the flatness of the laminated face of the laminating material, to thereby form the secondary formed product by pressurization. For example, in the first press apparatus, a lower board is provided so as to be movable up and down with respect to the fixed upper board. The first press apparatus has a pressurizing means such as a hydraulic cylinder. Pressure blocks (not shown) are provided on the opposed faces of the upper board and the lower board. A temperature control means such as a cartridge heater is provided on the pressure blocks. A cushioning material such as rubber or a resin film is attached to the surface of the pressure blocks. A second press apparatus is disposed in series on the downstream side with respect to the first press apparatus. The second press apparatus further pressurizes the secondary formed product to form a flat tertiary formed product. The tertiary formed product is a laminated product obtained by the lamination-forming system 100.

In the case where the lamination-forming system 100 includes a laminator and a planarizing press apparatus, the secondary formed product and the tertiary formed product are also lamination-formed products obtained by pressurizing the object to be laminated. The lamination-formed product conveyed from the forming apparatus 20 to the cooling apparatus 30 is a cooling object to be cooled in the cooling apparatus 30. In each drawing, the primary formed product, the secondary formed product, and the tertiary formed product are referred to as the substrate W, respectively. The second press apparatus may have the same configuration as the first press apparatus.

The cooling apparatus 30 may be provided in the lamination-forming system on the downstream side with respect to the forming apparatus 20. In other words, the cooling apparatus 30 is a cooling unit, disposed in the lamination-forming system at part on a downstream side with respect to the laminator, for cooling the lamination-formed product. The cooling apparatus 30 has an air flow generation means for causing a cooling air to flow in a direction inclined at a predetermined angle with respect to a direction substantially perpendicular to the conveyance direction, toward a downstream side in the conveyance direction. The airflow generation means may be, for example, a cooling fan with rotary vanes. The airflow generation means may be another blowing mechanism such as a slit air nozzle.

An example in which the airflow generation means is a plurality of cooling fans 31 will be described. The number of the cooling fans 31 is not limited to the following examples, and the airflow generation means may be a single cooling fan 31.

The cooling apparatus 30 includes a plurality of cooling fans 31. The cooling fans 31 are arranged along the conveyance direction. In the example shown in FIG. 1, five cooling fans 31 are arranged in the conveyance direction on the upper face side of the substrate W. On the lower face side of the substrate W, five cooling fans 31 are arranged in the conveyance direction. The heated substrate W is conveyed to the cooling apparatus 30 while being sandwiched between the upper film F1 and the lower film F2. The configuration of the cooling apparatus will be described in detail later.

The collection apparatus 40 is provided on the downstream side with respect to the cooling apparatus 30. The collection apparatus 40 includes an upper-film winding apparatus 41 and a lower-film winding apparatus 42. The collection apparatus 40 corresponds to a “film winder”. The collection apparatus 40 has a function of collecting a laminated product (a substrate W that has been laminated) in addition to collecting a carrier film. The collection apparatus 40 performs transfer of the upper film F1 and the lower film F2 in cooperation with the feeding apparatus 10. That is, the feeding apparatus 10 and the collection apparatus 40 convey the substrate W in the conveyance direction along the conveyance face. The rotation of the upper-film winding apparatus 41 and that of the lower-film winding apparatus 42 are controlled by motors (not shown), respectively. The upper-film winding apparatus 41 controls the feed amount and the film tension of the upper-film F1 between the upper-film winding apparatus 41 and the upper-film unwinding apparatus 11. The lower-film winding apparatus 42 controls the feed amount and the film tension of the lower-film F2 between the lower-film winding apparatus 42 and the lower-film unwinding apparatus 13.

The orientation of the upper-film F1 is turned upward via at least one driven roll and the upper-film F1 is wound up by the upper-film winding apparatus 41. After the upper-film F1 is wound up, the lower-film F2 is conveyed horizontally to another driven roll for a fixed distance. This portion serves as a discharge port from which the laminated the substrate W is discharged. After that, the lower film F2 is wound up by the lower-film winding apparatus 42 provided below via at least one driven roller.

Although not shown here, the lamination-forming system 100 may be provided with a control apparatus for controlling the entire lamination-forming system 100 which is connected to the feeding apparatus 10, the forming apparatus 20, the cooling apparatus 30, and the collection apparatus 40. The control apparatus includes a processor and a memory, and the processor can execute a program stored in the memory to control the operation of each unit, such as the conveyance of the substrate W or the lamination processing. The control apparatus may also have a function of a flow rate adjusting means for adjusting the flow rate of the cooling air caused to flow from the cooling apparatus 30.

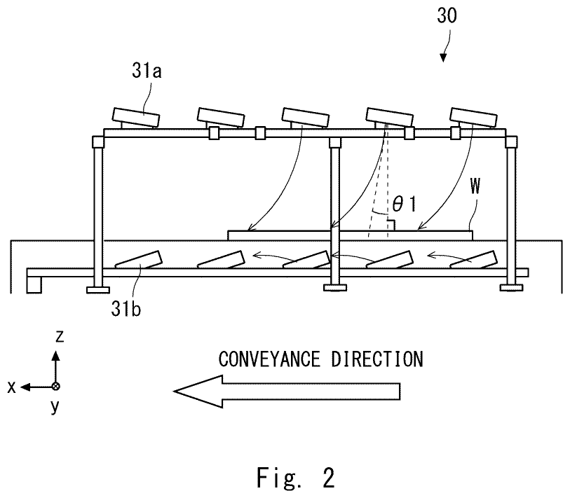

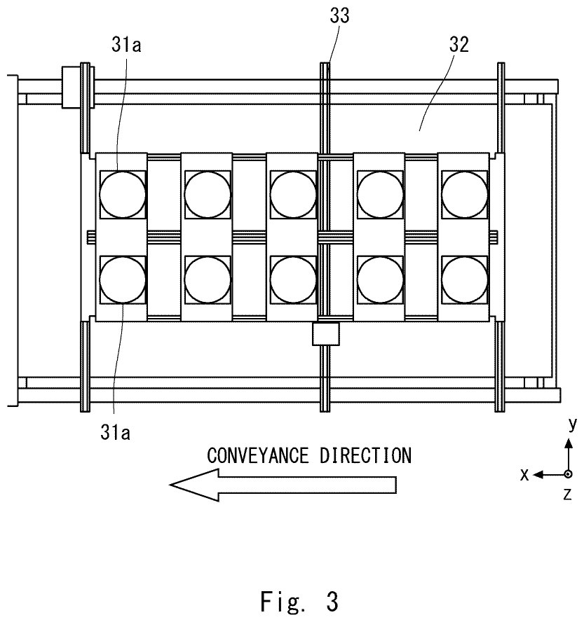

The cooling apparatus 30 will now be described with reference to FIGS. 2 and 3. FIG. 2 is a side view of the cooling apparatus 30 shown in FIG. 1. FIG. 3 is a top view of the cooling apparatus 30. In FIGS. 2 and 3, the conveyance direction is defined as the x-direction, and the direction perpendicular to the x-direction in the conveyance face is defined as the y-direction. The direction perpendicular to the conveyance face is defined as the z-direction. Among the plurality of cooling fans 31, the cooling fans 31 disposed on the upper face side of the substrate W are referred to as upper-side cooling fans 31a, and the cooling fans 31 disposed on the lower-face side of the substrate W are referred to as lower-side cooling fans 31b. In the cooling apparatus 30, the region where the substrate W heated by the forming apparatus stops and is cooled by the cooling fans 31 is referred to as a cooling stage 32.

As shown in FIG. 3, when viewed from the top, two rows of five upper-side cooling fans 31a arranged along the conveyance direction are arranged in the y-direction. That is, the cooling apparatus 30 includes ten upper-side cooling fans 31a. Although not illustrated herein, ten lower-side cooling fans 31b may be provided in the same manner as the upper-side cooling fans 31a. That is, two rows of five lower-side cooling fans 31b arranged in the conveyance direction may be arranged in the y-direction below the lower film F2. Thus, by providing the cooling fans 31 above and below the substrate W, the substrate W can be rapidly cooled. Further, the plurality of cooling fans 31 are disposed in a grid pattern, so that the entire surface of the substrate W can be efficiently cooled.

The spacing between the adjacent cooling fans 31 may be constant. The spacing between the adjacent cooling fans 31 may differ among the cooling fans 31. For example, the spacing between the upstream-side cooling fans 31 may be smaller than the spacing between the downstream-side cooling fans 31.

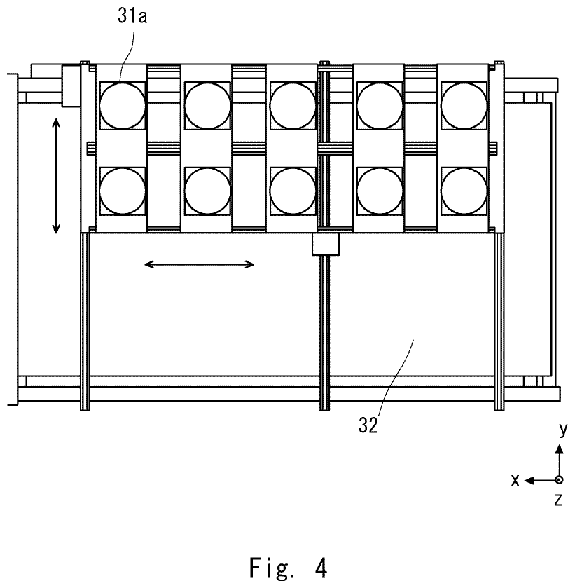

In the example shown in FIG. 3, the upper-side cooling fans 31a are mounted on a rail provided across the cooling stage 32 in the y-direction. The upper-side cooling fans 31a are movable in the direction orthogonal to the conveyance direction. FIG. 4 shows a state in which the upper-side cooling fans 31a are retracted from the top of the cooling stage 32. In the lamination-forming system 100, when the laminate film is replaced or the cooling stage 32 is subjected to maintenance, the upper-side cooling fans 31a can be retracted from above the cooling stage 32 to the side thereof as shown in FIG. 4. This configuration makes it easier for an operator to perform his/her work and thus maintainability of the lamination-forming system 100 is improved. The cooling fans 31 may be movable in at least one of the following directions: the conveyance direction (the x-direction), the direction substantially perpendicular to the conveyance direction (the y-direction) with respect to the conveyance face, and the direction substantially perpendicular to the conveyance face (the z-direction).

As shown in FIG. 2, the cooling fans 31 cause the cooling air to flow toward the substrate W in a direction inclined by a predetermined angle θ1 from a direction substantially perpendicular to the conveyance face (the z-direction) toward the downstream side in the conveyance direction (the x-direction). Specifically, the upper-side cooling fans 31a cause the cooling air to flow in the direction inclined to the downstream side in the conveyance direction with respect to a direction perpendicular to the upper face of the substrate W. The lower-side cooling fans 31b also cause the cooling air to flow in the direction inclined to the downstream side in the conveyance direction with respect to a direction perpendicular to the lower face of the substrate W.

In a comparative example in which the cooling fans 31 cause the cooling air to flow in a direction perpendicular to the substrate W, the cooling air that hits the substrate W flows toward the forming apparatus 20 side, and particles may enter the forming apparatus 20 from the cooling apparatus 30 side. As a result, particles may enter between the substrate W and the upper film F1 and the lower film F2, or between these films and the hot plate, resulting in a defect.

On the other hand, in the embodiment, the cooling air from the cooling fans 31 is inclined at a predetermined angle θ1, from a direction perpendicular to the substrate W toward the downstream side in the conveyance direction. Therefore, the cooling air flows toward the collection apparatus 40 on the downstream side in the conveyance direction and does not flow toward the forming apparatus 20 on the upstream side in the conveyance direction. Thus, it is possible to prevent particles from entering the forming apparatus 20 from the cooling apparatus 30 side, and to suppress contamination inside the housing of the forming apparatus 20, including the forming stage and the substrate W.

Moreover, since the cooling air does not flow toward the forming apparatus 20 side, it is possible to prevent components other than the substrate W from being cooled. For example, it is possible to prevent a hot plate provided in the forming apparatus 20 on the upstream side with respect to the cooling apparatus 30 from being cooled. Moreover, the air warmed by cooling the substrate W can flow outside the lamination-forming system 100 from the discharge port of the substrate W on the downstream side.

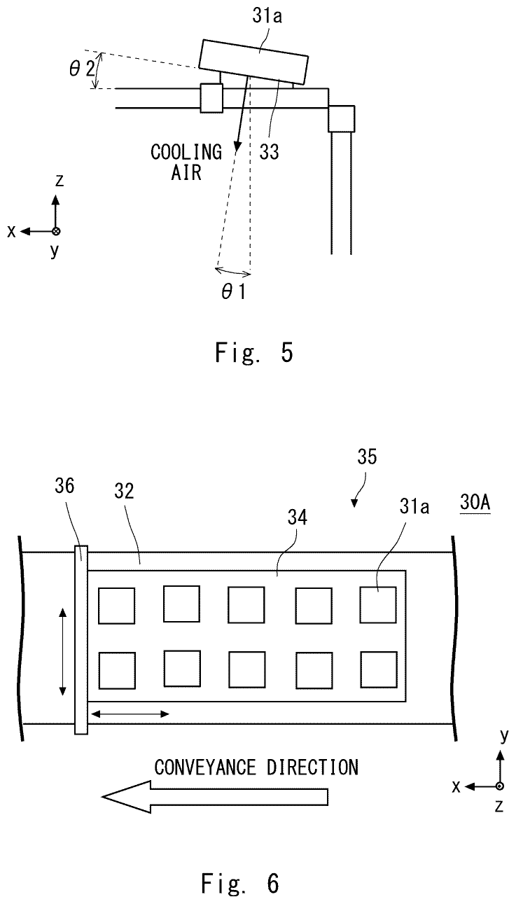

FIG. 5 is a diagram for explaining the mounting angle of the upper-side cooling fans 31a. It is assumed that the direction of the cooling air coming out of the upper-side cooling fans 31a is perpendicular to a blowing face 33 of the upper-side cooling fans 31a for blowing cooling air. An angle θ2 formed by the blowing face 33 of the upper-side cooling fans 31a and the xy-plane parallel to the conveyance face is defined as the mounting angle. The plurality of the upper-side cooling fans 31a are installed at an inclined angle so that the blowing face 33 faces the downstream side in the conveyance direction. The mounting angles of the plurality of upper-side cooling fans 31a are equal to each other. The aforementioned angle θ2 is equal to the angle θ1 at which the cooling air from the upper-side cooling fans 31a is inclined from a direction perpendicular to the substrate W toward the downstream side in the conveyance direction.

Although not illustrated herein, the plurality of the lower-side cooling fans 31b are installed at an angle θ2 so that the blowing face 33 faces the downstream side in the conveyance direction. The aforementioned angle θ2 is equal to the angle θ1 at which the cooling air from the lower-side cooling fans 31b is inclined from a direction perpendicular to the substrate W toward the downstream side in the conveyance direction. Thus, the mounting angle of the plurality of upper-side cooling fans 31a and the mounting angle of the plurality of the lower-side cooling fans 31b are fixed, so that the installation of the cooling fans 31 can be facilitated.

The angle θ2 is, for example, 5 to 30 degrees, and preferably 10 to 20 degrees. For example, the mounting angle (angle θ2) of the plurality of the cooling fans 31 may be 15 degrees. The mounting angle of each cooling fans 31 may be different depending on the spacing between adjacent cooling fans 31, the balance between the upper-side cooling fans 31a and the lower-side cooling fans 31b, and the like. For example, the mounting angle of the most upstream-side cooling fan 31 may be 45 degrees, and the mounting angle of the cooling fans 31 may become smaller toward the downstream side.

When the substrates W are loaded from the forming apparatus 20 into the cooling apparatus 30 at the above-described pitch, there may be a case where a substrate W is stopped at a location on the upstream side of the cooling stage 32 and there is no substrate W disposed on the downstream side of the cooling stage 32. In this case, the above-described control apparatus may adjust the flow rate of cooling air from the plurality of the cooling fans 31 so that the flow rate of the cooling air caused to flow to the upstream-side region in the conveyance direction is larger than the flow rate of the cooling air caused to flow to the downstream-side region. Thus, it is possible to cause a strong cooling air to flow to the location where a substrate W is disposed, and the substrate W can be efficiently cooled.

The above-described control apparatus may adjust the flow rate of cooling air from the cooling fans by configuring a part of the plurality of cooling fans so that the flow rate of the cooling air caused to flow from the cooling fans disposed on the downstream side in the conveyance direction is larger than the flow rate of the cooling air caused to flow from the cooling fans disposed on the upstream side in the conveyance direction. Generally, when the flow rate of the cooling air caused to flow from the downstream side is small, the cooling air caused to flow from the upstream side is clogged thereby flowing sideward. As described above, by partially increasing the flow rate of the cooling air caused to flow from the cooling fans on the downstream side, the cooling air caused to flow from the cooling fans on the upstream side can be made to flow more easily toward the downstream side. Thus, the cooling air can be made to flow in one direction along the conveyance direction. In addition, it is possible to suppress the entrainment of dust caused by the generation of turbulence at the discharge port and the backflow caused by the bouncing of the air that hits the inner face of the housing.

Note that the cooling apparatus 30 may include a measuring means measuring the temperature of the substrate W. The control apparatus can adjust the flow rate of the cooling air from the plurality of cooling fans 31 according to the temperature of the substrate W. The control apparatus can also adjust the flow rate of the cooling air by, for example, changing the number of the cooling fans to be operated out of the plurality of the cooling fans 31. For example, the control apparatus can set the cooling air generated by the cooling fans 31 to be “strong wind” by operating ten upper-side cooling fans 31a, “medium wind” by operating half (five) of the ten upper-side cooling fans 31a, and “weak wind” by operating ⅕ of the ten upper-side cooling fans 31a.

### Second Embodiment

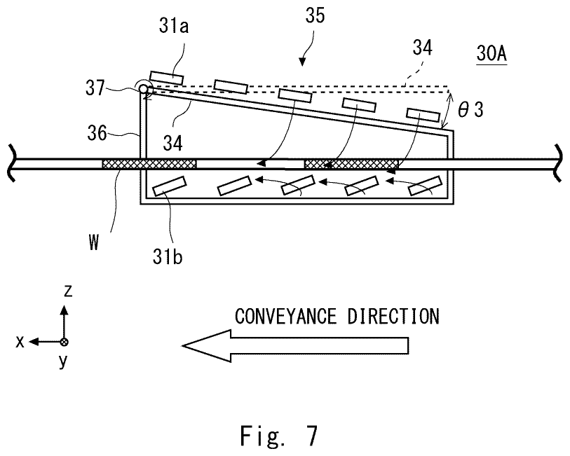

The lamination-forming system 100 according to a second embodiment includes the feeding apparatus 10, the forming apparatus 20, the cooling apparatus 30A, and the collection apparatus 40. Since the feeding apparatus 10, the forming apparatus 20, and the collection apparatus 40 are the same as those of the first embodiment, redundant descriptions will be omitted. FIG. 6 is a top view of the cooling apparatus 30A. FIG. 7 is a side view of the cooling apparatus 30A. In FIGS. 6 and 7, the conveyance direction is defined as the x-direction, and the direction perpendicular to the x-direction in the conveyance face is defined as the y-direction. The direction perpendicular to conveyance face is defined as the z-direction.

In the second embodiment, a plurality of upper-side cooling fans 31a are attached to one mounting plate 34. As shown in FIG. 6, when viewed from the top, a row of five upper-side cooling fans 31a arranged in the conveyance direction is attached to one mounting plate 34 so that two rows are arranged in the y-direction. That is, the cooling apparatus 30A includes a cooling fan unit 35 in which ten upper-side cooling fans 31a are attached to the mounting plate 34.

The cooling fan unit 35 is movable in at least one of the following directions: the conveyance direction (the x-direction), a direction substantially perpendicular to the conveyance direction in the conveyance face (the y-direction), and a direction substantially perpendicular to the conveyance face (the z-direction). This makes it possible to retract the upper-side cooling fans 31a from above the cooling stage 32 to the side when replacing the laminate film or performing maintenance work of the cooling stage 32.

Here, the direction of the cooling air blown out from the upper-side cooling fans 31a is assumed to be perpendicular to the blowing face 33 of the cooling air from the upper-side cooling fans 31a. The plurality of the upper-side cooling fans 31a are attached to the mounting plate 34 so that the blowing face 33 is substantially perpendicular to the conveyance face in the case where the mounting plate 34 is parallel to the conveyance face.

As shown in FIGS. 5 and 6, a frame 36 is provided across the cooling stage 32 in the y-direction. A side part of the mounting plate 34 on the downstream side is connected to the frame 36 so as to be rotatable about a pivot shaft 37. By rotating the mounting plate 34 downward from a state parallel to the conveyance face at an angle θ3 about the pivot shaft 37, the angle at which the cooling air from the plurality of upper-side cooling fans 31a is caused to flow can be changed simultaneously.

When the mounting plate 34 is tilted by an angle θ3, each of the upper-side cooling fans 31a can cause the cooling air to flow toward the substrate W in a direction inclined by a predetermined angle θ1 toward the downstream side in the conveyance direction (the x-direction) from a direction substantially perpendicular to the conveyance face (the z-direction). This makes it possible to easily change the angle of the cooling air from the plurality of upper-side cooling fans 31a.

As described above, according to the embodiment, it is possible to prevent particles from entering the forming apparatus 20 by suppressing the cooling air from flowing toward the upstream side in the conveyance direction. Moreover, by making the mounting position, the mounting angle, and the number of the cooling fans 31 to be actuated variable, it is possible to efficiently cool the substrate W. Moreover, by making the cooling fans 31 retractable from the cooling stage 32, maintainability can be improved.

It should be noted that the present disclosure is not limited to the above-described embodiment, and the present disclosure can be appropriately modified without departing from the purport. In the above-described example, the direction of cooling air is changed by changing the mounting angle of cooling fans 31, but the present disclosure is not limited thereto. For example, it is possible to change the direction of the cooling air by providing a louver in front of the blowing face 33 of the cooling fans 31.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A lamination-forming system, comprising:
a pair of carrier films for sandwiching an object to be laminated, formed by laminating a laminate material on a lamination-target body, between the pair of carrier films from above and below and conveying the object to be laminated along a conveyance direction;
a film unwinder for unwinding the carrier film;
a laminator for pressing the object to be laminated to form a lamination-formed product, the laminator being disposed on a downstream side with respect to the film unwinder;
a cooling unit configured to cool the lamination-formed product, the cooling unit being disposed on a downstream side with respect to the laminator; and
a film winder for unloading the lamination-formed product mounted on the carrier film, the film winder being disposed on the downstream side with respect to the laminator,
wherein the cooling unit includes an airflow generation unit configured to cause a cooling air to flow in a direction inclined at a predetermined angle with respect to a direction substantially perpendicular to the conveyance direction, toward a downstream side in the conveyance direction.

2. The lamination-forming system according to claim 1, wherein the cooling unit includes a plurality of the airflow generation units arranged along the conveyance direction.

3. The lamination-forming system according to claim 2, wherein the airflow generation unit is a cooling fan with rotary vanes.

4. The lamination-forming system according to claim 1, further comprising a planarizing press apparatus for pressurizing the lamination-formed product to increase the flatness of a laminated face of the laminate material, the planarizing press apparatus being disposed on the downstream side with respect to the laminator,
wherein the cooling unit is disposed on the downstream side with respect to the planarizing press apparatus.

5. The lamination-forming system according to claim 2, wherein the cooling unit includes a flow rate adjusting unit configured to adjust the flow rate of the cooling air from the plurality of airflow generation units so that a flow rate of the cooling air caused to flow to an upstream-side region in the conveyance direction is larger than a flow rate of the cooling air caused to flow to a downstream-side region in the conveyance direction.

6. The lamination-forming system according to claim 5, wherein the flow rate adjusting unit adjusts the flow rate of the cooling air from a part of the plurality of the airflow generation units so that a flow rate of the cooling air caused to flow from the airflow generation units disposed on the downstream side in the conveyance direction is larger than a flow rate of the cooling air caused to flow from the airflow generation units disposed on the upstream side in the conveyance direction.

7. The lamination-forming system according to claim 1, further comprising:
a measuring unit configured to measure a temperature of the lamination-formed product; and
a flow rate adjusting unit configured to adjust the flow rate of cooling air from the plurality of airflow generation units according to the temperature of the lamination-formed product.

8. The lamination-forming system according to claim 5, wherein the flow rate adjusting unit adjusts the flow rate of the cooling air by changing the number of the airflow generation units to be operated among the plurality of the airflow generation units.

9. The lamination-forming system according to claim 1, wherein the plurality of the airflow generation units are movable in at least one of the conveyance direction, a direction substantially perpendicular to the conveyance direction in the conveyance face, and a direction substantially perpendicular to the conveyance face.

10. The lamination-forming system according to claim 3, wherein the mounting angles of the plurality of the cooling fans with respect to a plane parallel to the conveyance face are equal to each other.

11. The lamination-forming system according to claim 3, wherein
the plurality of the cooling fans are respectively attached to one mounting plate, and
the angle at which the cooling air blown from the plurality of the cooling fan is caused to flow is changed simultaneously by tilting the mounting plate with respect to the plane parallel to the conveyance face.

12. The lamination-forming system according to claim 3,
wherein the cooling unit includes:
a plurality of upper-side cooling fans disposed on an upper-face side of the lamination-formed product; and
a plurality of lower-side cooling fans disposed on a lower-face side of the lamination-formed product,
wherein the upper-side cooling fans cause the cooling air to flow from a direction perpendicular to the upper face of the lamination-formed product toward a direction inclined to the downstream side in the conveyance direction, and
wherein the lower-side cooling fans cause the cooling air to flow from a direction perpendicular to the lower face of the lamination-formed product toward a direction inclined to the downstream side in the conveyance direction.

13. A method of manufacturing a lamination-formed product, comprising:
sandwiching an object to be laminated, formed by laminating a laminate material on a lamination-target body, between a pair of carrier films from above and below and conveying the object to be laminated along a conveyance direction;
pressing the conveyed object to be laminated to form a lamination-formed product;
performing cooling by an air flow generation unit configured to cause a cooling air to flow in a direction inclined at a predetermined angle with respect to a direction substantially perpendicular to the conveyance direction, toward a downstream side in the conveyance direction; and
unloading the lamination-formed product mounted on the carrier film.
